(19) United States
(12) Patent Application Publication
(10) Pub. No.: US 2026/0054846 A1
(43) Pub. Date: Feb. 26, 2026

(54) Device to Secure an Engine Cowling to an Aircraft Engine

(71) Applicant: The Boeing Company, Arlington, VA (US)

(72) Inventor: Michael Shawn Brannon, Summerville, SC (US)

(21) Appl. No.: 18/811,888

(22) Filed: Aug. 22, 2024

(51) Int. Cl. B64D 29/06

(52) U.S. Cl. CPC B64D 29/06

(57) ABSTRACT

A device to secure a cowl to an engine of an aircraft. The device has a support member with an elongated shape with a first end section configured to be connected to the engine and an opposing second end section configured to be connected to the cowl. A first connector and a second connector are positioned at the second end section to connect the support member to the cowl. The second connector is weaker than the first connector and configured to fail in a fan blade off event to enable the cowl to remain connected to the support member at the first connector and to enable the cowl to move radially outward away from the engine and the first end section of the support member.

### TECHNOLOGICAL FIELD

The present disclosure relates generally to the field of aircraft engines and, more specifically, to a connector that connects a cowl to an aircraft engine.

### BACKGROUND

A jet engine of an aircraft includes a nacelle that extends around the exterior of the engine. The nacelle forms a housing that protects the engine. The nacelle is often divided into multiple sections. Examples of sections include one or more cowls (e.g., inlet cowl, fan cowl) and a thrust reverser. The nacelle includes an aerodynamic shape due to its exposed position on the exterior of the aircraft, such as on the wing of the aircraft. The nacelle is also shaped to be aerodynamically efficient.

The nacelle is designed to withstand a fan blade off (FBO) event. An FBO event occurs when a blade of the fan breaks off or is otherwise released from the fan. The high rotational speed of the fan causes the released blade to be propelled radially outward away from the engine and into contact with a fan case on the interior of the nacelle. The released blade imparts a large amount of energy to the nacelle. The nacelle is designed to withstand the FBO event. This includes containing the fan blade and preventing the entirety or sections of the nacelle from being released from the aircraft. This containment by the nacelle prevents the various engine parts from being released which could damage other sections of the aircraft, such as but not limited to the wing and tail section including the rudder.

Current solutions to this issue include designing the nacelle to be stronger and/or stiffer to withstand the large fan blade loads. These solutions add weight and size to the nacelle which decreases the overall efficiency and/or aerodynamics of the aircraft.

### SUMMARY

One aspect is directed to a device to secure a cowl to an engine of an aircraft. The device comprises a support member with an elongated shape and comprising a first end section configured to be connected to the engine and an opposing second end section configured to be connected to the cowl. A first connector and a second connector are positioned at the second end section to connect the support member to the cowl. The second connector is weaker than the first connector and configured to fail in a fan blade off event to enable the cowl to remain connected to the support member at the first connector and to enable the cowl to move radially outward away from the engine and the first end section of the support member.

In another aspect, the first connector and second connector prevent the cowl from pivoting relative to the support member when the first connector and second connector are secured to the cowl.

In another aspect, the first connector and the second connector are connected at positions that are spaced apart along a longitudinal length of the support member and wherein the second connector is connected inward from the first connector along the longitudinal length.

In another aspect, the support member comprises multiple links that are pivotally connected together.

In another aspect, the second connector is a fusible link.

In another aspect, an anchor is connected to the cowl and wherein the first connector and the second connector connect the support member to the anchor.

In another aspect, a slot extends into the anchor and wherein the support member is positioned in the slot.

In another aspect, the support member comprises an opening and the second connector extends through the opening.

One aspect is directed to a device to secure a cowl to an engine of an aircraft. The device comprises a support member with an elongated shape and comprises a first section and a second section with the first section connected to the engine. An anchor is connected to the cowl. A first connector connects the second section of the support member to the anchor. A second connector connects the second section of the support member to the anchor with the second connector being spaced apart from the first connector along the second section. The second connector is configured to fail upon application of a force to the cowl above a predetermined amount. The first connector is configured to remain connected to the cowl after the second connector breaks and to enable the cowl to move relative to the engine.

In another aspect, the first connector is configured to enable the cowl to move radially outward away from the engine after failure of the second connector.

In another aspect, the first connector and the second connector prevent movement of the second section of the support member relative to the anchor when the first connector and the second connector are connected to the support member.

In another aspect, each of the first connector and the second connector extend through the second section of the support member.

In another aspect, the first connector is connected to the support member at a second end of the support member.

In another aspect, the second connector is weaker than the first connector.

In another aspect, the anchor comprises a slot and wherein the second section of the support member is positioned in the slot when the first connector and the second connector are connected to the support member.

In another aspect, the support member comprises multiple links that are pivotally connected together at one or more pivots and the pivots are positioned along the support member away from the anchor.

One aspect is directed to a method of connecting a cowl to an engine of an aircraft. The method comprises: positioning a cowl in a closed position with the cowl connected to the engine through an elongated support member; preventing the cowl from moving relative to the engine during normal operation with a first connector and a second connector connecting the support member to the cowl; and after a fan blade off event and the second connector fails, maintaining the first connector connected to the cowl and enabling the cowl to move relative to the engine.

In another aspect, the method further comprises positioning the second connector to break during the fan blade off event.

In another aspect, the method further comprises enabling the cowl to move radially outward from the engine after the second connector breaks.

In another aspect, the method further comprises positioning a fusible section of the second connector in a slot in an anchor during the normal operation.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is an isometric view of an aircraft.

FIG. 2 is a schematic section view of a fan cowl in a closed position with support members connecting the fan cowl to an engine.

FIG. 3 is a schematic side view of a support member connecting a fan cowl to an engine.

FIG. 4 is a side view of a fan cowl in a closed position and connected to an anchor and a support member.

FIG. 5 is an isometric view of the anchor and support member of FIG. 4.

FIG. 6 is a schematic view of a connector connecting a link of a support member to an anchor.

FIG. 7 is a side schematic view of a fan cowl in an open position with a support member connecting to the fan cowl to an engine.

FIG. 8 is a flowchart diagram of a method of connecting a cowl to an engine of an aircraft.

### DETAILED DESCRIPTION

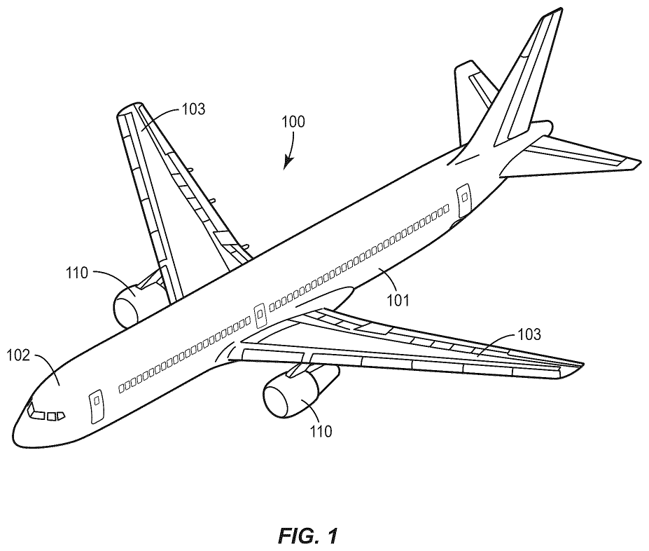

FIG. 1 illustrates an aircraft 100 configured to transport passengers and/or cargo. The aircraft 100 generally includes a fuselage 101 with an interior space configured to accommodate the passengers and/or cargo. The interior space of the fuselage 101 also includes a flight deck 102 with various controls to enable flight personnel to control the aircraft 100. Engines 110 are mounted on the wings 103 on opposing sides of the fuselage 101.

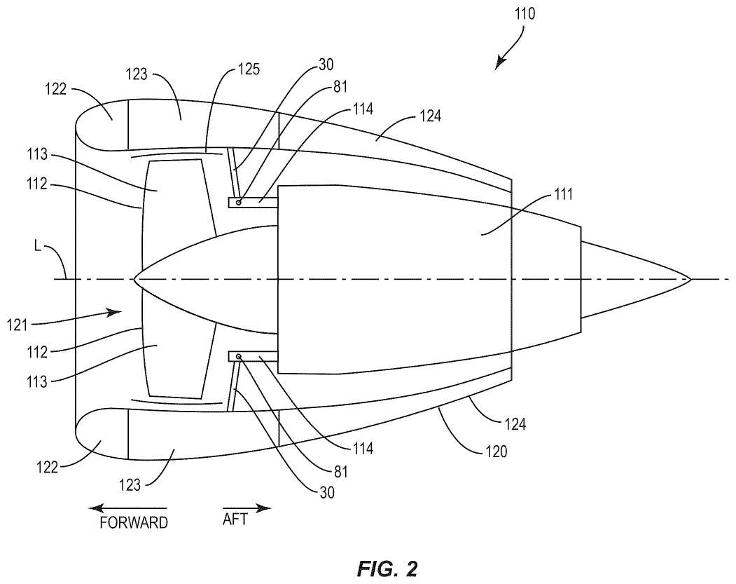

FIG. 2 schematically illustrates a sectional view of the engine 110. The engine 110 includes an engine core 111 and a nacelle 120. The engine core 111 can include a variety of different configurations, including but not limited to a gas turbine engine. The engine 110 includes a fan 112 with blades 113 to draw air into the engine core 111. A fan case 125 is positioned radially outward from the fan 112. The engine 110 also includes a frame 114 that supports the engine core 111 and provides for attachment to the wing 103.

The nacelle 120 extends around and protects the engine core 111 and fan 112. The nacelle 120 includes a generally cylindrical shape with an inlet 121 through which air is drawn into the fan 112 and engine core 111. The nacelle 120 is divided into multiple different sections along its length. An inlet cowl 122 is positioned at a forward end of the nacelle 120. A fan cowl 123 is positioned aft of the inlet cowl 122 and is aligned to extend around the fan 112. The nacelle 120 also includes a thrust reverse 124 aft of the fan cowl 123. The thrust reverser 124 is configured to translate along a longitudinal axis L relative to the engine core 111. The various sections of the nacelle 120 including the fan cowl 123 are connected to the frame 114.

The fan cowl 123 generally has an overall annular shape to extend around the perimeter of the fan 112. The fan cowl 123 is constructed from multiple different sections that each extend around a limited angular section of the fan 112. In one example, the fan cowl 123 includes two separate sections each having a substantially C-shape that extend around one-half of the fan 112. Each of the sections of the fan cowl 123 are connected to the frame 114 through one or more support members 30.

During an FBO event, one or more of the blades 113 breaks off from the fan 112. This can include an entire blade or a section of the blade. The rotation of the fan 112 causes the blades 113 to move radially outward away from the fan 112 and are contained by the fan case 125. This impact creates large loads and displacements. The fan cowl 123 is constructed to withstand these forces and remain attached to the engine 110. Previous designs have attempted to accomplish these requirements by using larger and heavier components. The present application accomplishes the requirements by a fusible link design that enables the fan cowl 123 to move radially outward away from the fan 112 to absorb the force that is applied by the one or more fan blades 113.

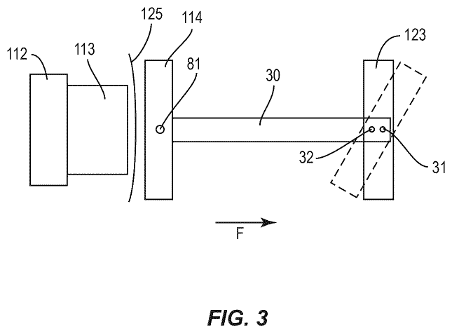

FIG. 3 illustrates a schematic diagram of the fan cowl 123 connected to the frame 114. The fan cowl 123 is positioned radially outward from the fan 112. The fan cowl 123 can include various sizes and extend around various angular sections of the fan 112. A support member 30 extends between and attaches the fan cowl 123 to the engine frame 114. An inner end section of the support member 30 is connected by one or more fasteners 81 to the engine frame 114. The fasteners 81 can be positioned at the end and/or inward from the end. An outer end section of the support member 30 is connected to the fan cowl 123 at a first connector 31 and a second connector 32. The connectors 31, 32 are positioned at different points along the length, and their placement can vary along the length of the support member 30.

The second connector 32 is a fusible link 32 configured to fail during an FBO event. In some examples, the second connector 32 is configured to remain structurally sound upon application of a force up to a predetermined amount. The second connector 32 is configured to fail upon application of a force greater than the predetermined amount. The amount of force applied during an FBO event is greater than the predetermined amount thus resulting with the second connector 32 failing.

During normal operation, the support member 30 remains attached to the fan cowl 123 through both the first connector 31 and the second connector 32. During an FBO event, the one or more fan blades 113 break away from the fan 112 and apply a force F indirectly through the fan case 125 to the fan cowl 123. This force F causes the second connector 32 to fail with the first connector 31 remaining attached to the fan cowl 123. This failure of the second connector 32 enables the fan cowl 123 to move radially outward away from the fan 112. In some examples, the force causes the fan cowl 123 to pivot outward about the first connector 31. The radially outward position of the fan cowl 123 after an FBO event is shown in dashed lines. This movement absorbs the force F applied by the blades 113. In some examples, the amount of movement is limited such that the released blades 113 remain within the interior of the nacelle 120. The fan cowl 123 remains attached to the frame 114 through the support member 30 and prevents the fan cowl 123 from detaching which could result in the fan cowl 123 striking and damaging another section of the aircraft 100.

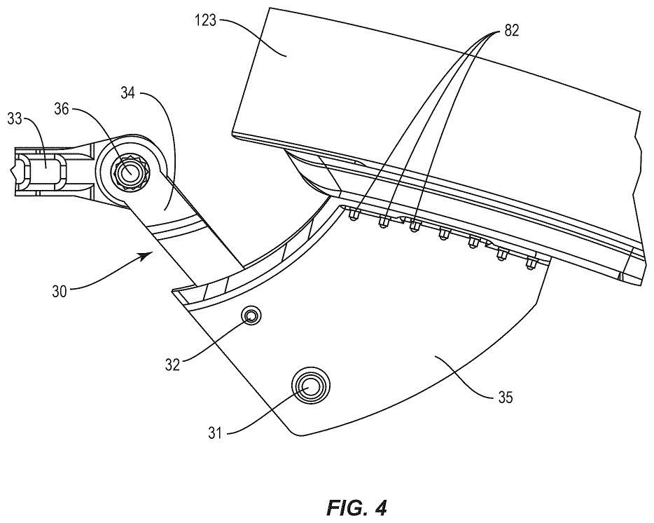

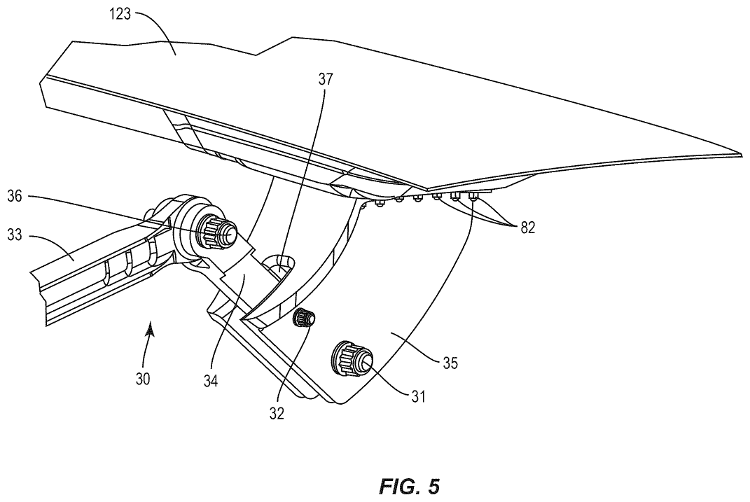

FIGS. 4 and 5 illustrate an example of the support member 30 connected to the fan cowl 123. This positioning occurs during normal operation of the engine 110 when the fan cowl 123 is in a closed position and aligned with the inlet cowl 122 and thrust reverser 124 (see FIG. 2). The support member 30 extends between and connects the fan cowl 123 to the engine frame 114 (not illustrated).

The support member 30 can include various number of components and configurations. Different examples include the support member 30 constructed as a single component as illustrated in FIG. 3, with other examples including two or more components. In the example of FIGS. 4 and 5, the support member 30 includes a first link 33 and a second link 34. Each of the links 33, 34 includes an elongated shape. An outer end of the first link 33 is connected to the engine frame 114, such as through one or more mechanical fasteners 81 (see FIGS. 2 and 3). The inner ends of the links 33, 34 are connected together by a mechanical fastener 36. The inner ends are pivotally connected together to enable the relative angle between the links 33, 34 to vary. In some examples, the fan cowl 123 can be moved to the open position by extending the support member 30 and pivoting the links 33, 34 about the fastener 36. This may be used during maintenance of the fan 112 with a technician opening the different sections of the fan cowl 123 and pivoting the sections outward and enabling access to the fan 112. In some examples, latches are positioned at the bottom of the fan cowl 123. During engine use, the latches are secured. To access the interior components such as engine systems that are mounted on the fan case, the latches are released and the sections of the fan cowl 123 are pivoted open about hinges.

In some examples, the second link 34 is directly connected to the fan cowl 123 (see FIG. 3). In other examples as illustrated in FIGS. 4 and 5, the second link 34 is connected to the fan cowl 123 through an anchor 35. The anchor 35 is secured to the fan cowl 123 with mechanical fasteners 82. An opposing side of the anchor 35 away from the fan cowl 123 includes a slot 37 sized to receive the second link 34. Connector 31 attaches the outer end of the second link 34 to the anchor 35. In some examples, the connector 31 extends across the slot 37 and through an opening in the second link 34. In some examples, the second connector 32 includes a fusible section that is positioned in the slot 37.

The second connector 32 is connected to the second link 34 inward from the first connector 31 (i.e., between the first connector 31 and the inner end of the second link 34). The second connector 32 is weaker than the first connector 31 to enable it to fail during an FBO event. In some examples, the entire second connector 32 is weaker than the first connector 31. In other examples, the second connector 32 includes one or more weakened fusible sections along the length that fail during the FBO event. These sections can include a weaker construction in various manners, including but not limited to being constructed from different materials than the remainder of the second connector, and having a smaller sectional size.

In some examples when both are connected, the first connector 31 and the second connector 32 prevent relative movement between the fan cowl 123 and the support member 30. In some examples, attachment of the first connector 31 and the second connector 32 prevents movement of the second link 34 relative to the anchor 35.

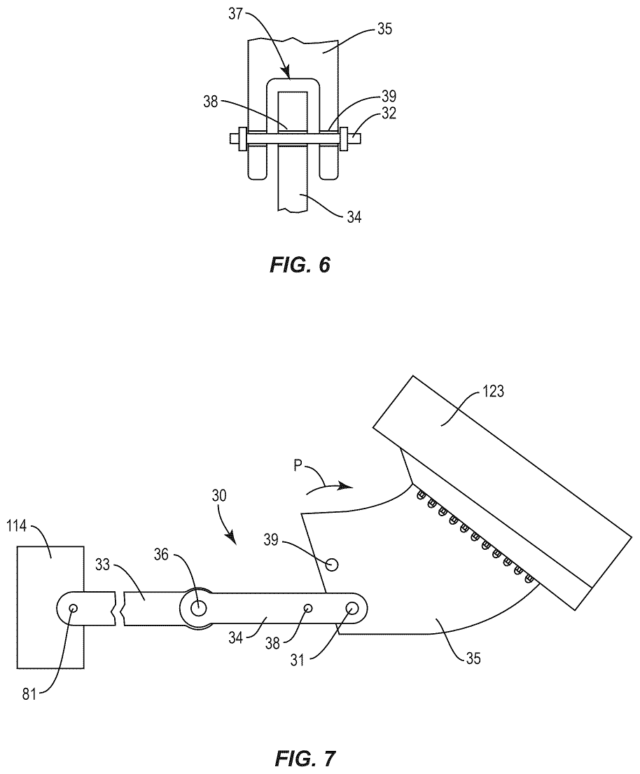

FIG. 6 illustrates a second connector 32 connecting the second link 34 to the anchor 35. The second connector 32 extends across the slot 37 in the anchor 35 and through an opening 38 in the second link 34. In some examples, the support member 30 includes openings sized to receive the first connector 31 and the second connector 32 respectively.

In some examples as illustrated in FIGS. 4 and 5, the anchor 35 includes a slot 37 that receives the second link 34. In other examples, the anchor 35 does not include a slot 37. The second link 34 is positioned along a side of the anchor 35. The first connector 31 and the second connector 32 secure the second link 34 to the side of the anchor 35.

During an FBO event, the force applied to the fan cowl 123 by the blades 113 causes the second connector 32 to fail. This enables the fan cowl 123 to move radially outward away from the fan 112. FIG. 7 illustrates an example of the support member 30 connecting the fan cowl 123 to the engine frame 114 after an FBO event. The second connector (not illustrated) which was connected to the anchor 35 at openings 38, 39 has failed. This causes the fan cowl 123 (and the anchor 35) to pivot outward about the first anchor 31 as illustrated by arrow P. This also decouples the fan cowl 123 from the continued forces imparted during the FBO event as the unbalanced engine continues to turn. This movement absorbs the force that is applied to the fan cowl 123. In some examples as further illustrated, the support member 30 adjusts by the first link 33 and second link 34 pivoting about fastener 36 to have a straighter configuration.

The movement of the fan cowl 123 during the FBO event absorbs the force applied by the one or more fan blades 113. The movement can occur through the pivoting locations at the first connector 31 the fastener 36. Each of these pivoting points enables the fan cowl 123 to move outward away from the fan 112 and thus absorb the force.

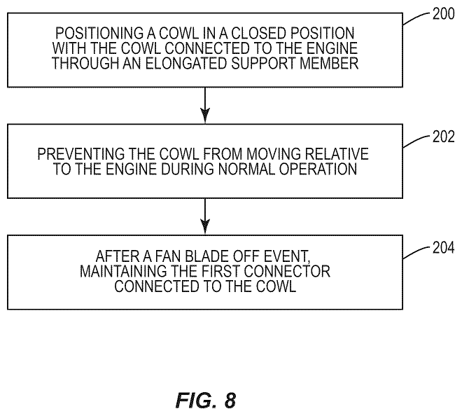

FIG. 8 illustrates a method of connecting a cowl 123 to an engine 110 of an aircraft 100. The method includes positioning the cowl 123 in a closed position with the cowl 123 connected to the engine 110 through an elongated support member 30 (block 200). During normal operation, the cowl 123 is prevented from moving relative to the engine 110 with a first connector 31 and a second connector 32 (block 202). After a fan blade off event and the second connector 32 fails, the cowl remains connected through the first connector 31 and enabling the cowl 123 to move relative to the engine 110 (block 204).

The support member 30 can be constructed from one or more links. The multiple links are connected together at pivots that are positioned away from the anchor 35.

The various fasteners disclosed to connect two or more parts together can include various configurations. Examples include but are not limited to screws, bolts, and rivets.

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A device to secure a cowl to an engine of an aircraft, the device comprising:
a support member with an elongated shape and comprising a first end section configured to be connected to the engine and an opposing second end section configured to be connected to the cowl;
a first connector and a second connector positioned at the second end section to connect the support member to the cowl; and
wherein the second connector is weaker than the first connector and configured to fail in a fan blade off event to enable the cowl to remain connected to the support member at the first connector and to enable the cowl to move radially outward away from the engine and the first end section of the support member.

2. The device of claim 1, wherein the first connector and second connector prevent the cowl from pivoting relative to the support member when the first connector and the second connector are secured to the cowl.

3. The device of claim 1, wherein the first connector and the second connector are connected at positions that are spaced apart along a longitudinal length of the support member and wherein the second connector is connected inward from the first connector along the longitudinal length.

4. The device of claim 1, wherein the support member comprises multiple links that are pivotally connected together.

5. The device of claim 1, wherein the second connector is a fusible link.

6. The device of claim 1, further comprising an anchor that is connected to the cowl and wherein the first connector and the second connector connect the support member to the anchor.

7. The device of claim 6, further comprising a slot that extends into the anchor and wherein the support member is positioned in the slot.

8. The device of claim 1, wherein the support member comprises an opening and the second connector extends through the opening.

9. A device to secure a cowl to an engine of an aircraft, the device comprising:
a support member with an elongated shape and comprising a first section and a second section connected together at a connection point and with the first section connected to the engine;
an anchor that is connected to the cowl;
a first connector that connects the second section of the support member to the anchor;
a second connector that connects the second section of the support member to the anchor, the second connector being spaced apart from the first connector along the second section and positioned closer to the connection point than the first connector along the second section and with the second connector being weaker than the first connector;
wherein the second connector is configured to fail upon application of a force to the cowl above a predetermined amount; and
wherein the first connector is configured to remain connected to the cowl after the second connector breaks and to enable the cowl to move relative to the engine.

10. The device of claim 9, wherein the first connector is configured to enable the cowl to move radially outward away from the engine after failure of the second connector.

11. The device of claim 9, wherein the first connector and the second connector prevent movement of the second section of the support member relative to the anchor when the first connector and the second connector are connected to the support member.

12. The device of claim 9, wherein each of the first connector and the second connector extend through the second section of the support member.

13. The device of claim 9, wherein the first connector is connected to the support member at a second end of the support member.

14. (canceled)

15. The device of claim 9, wherein the anchor comprises a slot and wherein the second section of the support member is positioned in the slot when the first connector and the second connector are connected to the support member.

16. The device of claim 9, wherein the connection point that connects the first section and the second section of the support member is positioned along the support member away from the anchor.

17. A method of connecting a cowl to an engine of an aircraft, the method comprising:
positioning a cowl in a closed position with the cowl connected to the engine through an elongated support member;
preventing the cowl from moving relative to the engine during normal operation with a first connector and a second connector connecting the support member to the cowl with the second connector being weaker than the first connector; and
after a fan blade off event and the second connector fails, maintaining the first connector connected to the cowl and enabling the cowl to move relative to the engine.

18. The method of claim 17, further comprising positioning the second connector to break during the fan blade off event.

19. The method of claim 17, further comprising enabling the cowl to move radially outward from the engine after the second connector breaks.

20. The method of claim 17, further comprising positioning a fusible section of the second connector in a slot in an anchor during the normal operation.

21. The method of claim 17, further comprising positioning the second connector closer to the engine than the first connector when the cowl is in a closed position.
